(19) United States
(12) Patent Application Publication
(10) Pub. No.: US 2018/0154572 A1
(43) Pub. Date: Jun. 7, 2018

(54) APPARATUS AND METHOD FOR CONTINUOUS TREATMENT OF A SOLID BODY BY MEANS OF LASER BEAM

(71) Applicant: SILTECTRA GmbH, Dresden (DE)

(72) Inventors: Jan Richter, Dresden (DE); Marko Swoboda, Dresden (DE)

(21) Appl. No.: 15/557,541

(22) PCT Filed: Feb. 14, 2016
(86) PCT No.: PCT/EP2016/055394

§ 371 Date: Jan. 16, 2018

(30) Foreign Application Priority Data
Mar. 12, 2015 (DE) 10 2015 003 193.7

(51) Int. Cl. B29C 59/16; B29C 59/00

(52) U.S. Cl. CPC B29C 59/16; B29C 59/002

(57) ABSTRACT

The invention relates to an apparatus (1) for treating solid bodies (2). The apparatus according to the invention comprises at least one receiving device (4) having a receiving portion (6) for receiving the solid body (2) and a holding portion (10) for holding the receiving portion (6), wherein the receiving portion (6) can be continuously driven by means of a drive device, a laser device (14) for providing laser beams (16) to generate modifications (18) in the solid body (8) or on a surface (20) of the solid body (2), and an optical system (20) for guiding the laser beams (16), wherein the laser beams (16) can be deflected by means of the optical system (20) such that one or more solid bodies (2) can be impinged by the laser beams (16) at different positions.

According to claim 1, the invention at hand refers to an apparatus for treating solid bodies and according to claim 15 to a method for treating solid bodies.

There are numerous types of solid body treatments, such as, e.g., the ion implantation, the etching, the coating or the machining. However, in particular a machining is disadvantageous, e.g. in the case of solid body materials, which are expensive or the production of which is extensive, respectively, such as, e.g., semiconductor materials or sapphire or silicon carbide, because the chips cause a significant material loss and thus high costs, e.g. in the case of very thin wafers. In the case of very thin wafers comprising a large diameter, significant thickness differences can further be determined as a result of the machining, whereby the wafers can only be used for certain applications. The thickness fluctuation can thereby be effected e.g. from oscillations of the sawing element.

It is thus the object of the invention at hand to provide an apparatus and a method for weakening the structure of a donor substrate, if possible in a chip-free manner.

According to the invention, the above-mentioned object is solved by an apparatus for treating solid bodies, in particular donor substrates. The apparatus according to the invention thereby preferably comprises at least one receiving device comprising a receiving portion for receiving the at least one solid body and a holding portion for holding the receiving portion, wherein the receiving portion can be continuously driven by means of a drive device, a laser device for providing laser beams to generate modifications in the solid body or on a surface of the solid body, and an optical system for guiding the laser beams, wherein the laser beams can be deflected by means of the optical system such that the at least one solid body can be impinged by the laser beams at different positions. The method further preferably also comprises the step of splitting off a solid body from the at least one solid body or the at least one donor substrate, respectively.

This solution is advantageous, because modifications can be generated successively for the first time on a plurality of modification paths, which differ from one another, without the requirement of a change of the drive speed and/or without a reversal of the drive device in the solid body. This provides for a significant acceleration of solid body treatment, whereby the production costs for such solid bodies or for products of such solid bodies can be reduced.

Further preferred embodiments are the subject matter of the subclaims or of the following description.

According to a further preferred embodiment of the invention at hand, the receiving portion is supported so as to be capable of rotating about an axis of rotation, wherein the solid body can be impinged by the laser beams at different or varying distances to the axis of rotation. The rotational speed of the receiving portion can preferably be varied by means of the drive device as a function of the distance of the location, at which the laser beams penetrate the solid body, to the axis of rotation, wherein the rotational speed preferably increases to the axis of rotation in response to a decrease of the distance of the location, at which the laser beams penetrate the solid body. This solution is advantageous, because the receiving portion can be rotated about the axis of rotation at more than 100 revolutions per minute, preferably at more than 1000 revolutions per minute and particularly preferably at more than 1500 revolutions per minute, in particular with maximally or more than 3000 revolutions per minute or with maximally or more than 5000 revolutions per minute or with maximally or more than 9000 revolutions per minute or with maximally or more than 15000 revolutions per minute. In response to an impinging of the solid body by laser beams emitted by the laser device at a frequency of at least 1 kHz or of maximally, equal to or at least 1 MHz or of maximally, equal to or at least 20 MHz or of maximally, equal to or at least 50 MHz or of maximally, equal to or at least 80 MHz or of maximally, equal to or at least 100 MHz or of maximally, equal to or at least 250 MHz or of maximally, equal to or at least 1 GHz, modifications can be generated on a modification path at very short distances of preferably less than 100 μm, preferably less than 50 μm and particularly preferably less than 20 μm or 10 μm or 5 μm or 4 μm or 3 μm or 2 μm or 1 μm or 0.5 μm.

According to a further preferred embodiment of the invention at hand, provision is made for a distance adaptation device for adapting the distance of at least one element of the optical system with respect to a surface portion of the surface of the solid body, wherein the distance adaptation device comprises at least one distance determination device to determine a distance of a surface portion of the solid body with respect to the distance determination device and a deflection device to adapt the distance of the at least one element of the optical system with respect to the surface portion of the solid body as a function of the distance between the surface portion of the solid body and the distance determination device determined by the distance determination device. The element of the optical system is hereby preferably a lens, in particular a rod lens or a scan module. This embodiment is advantageous, because unevenness can be detected. According to this solution, the modifications can thus always be generated in the same or substantially in the same depth, respectively, in the material.

According to a further preferred embodiment of the invention at hand, the distance determination device is arranged in such a way that the distance determination occurs at a location, which differs from the location of the introduction of the laser beams into the solid body. This embodiment is advantageous, because the measurement is preferably carried out as function of the speed of the holding portion on a certain modification path, and the deflection device is controlled as a function of the measurement. Depending on the control speed and reaction time of the deflection device and on the maximum speed of the receiving portion, the distance determination device can be spaced apart accordingly from the location of the laser impingement. The location of the distance determination and the location, at which the laser radiation penetrates the solid body, are preferably located on a circular path, in particular on the same circular path around the axis of rotation, wherein the location of the distance determination and the location, at which the laser beams penetrate the solid body, are spaced apart from one another by less than 270°, preferably by less than 180°, and particularly preferably by less than 90°.

According to a further embodiment of the invention at hand, at least the one element of the optical system can be deflected in such a way by means of the deflection device that distance changes between the optical system and the surface portion of the solid body can be compensated least partially, wherein the deflection device can be controlled as a function of the rotational speed of the receiving portion in such a way that the laser beams for generating the modification(s) penetrate the solid body through the surface of the surface portion of the solid body, at which the distance measurement occurred beforehand. It is conceivable hereby that the modification path, on which the distance is captured and on which the modification is generated, has or forms, respectively, a straight or curved, in particular circular shape.

According to a further preferred embodiment of the invention at hand, the deflection device has at least one actuator, in particular a piezo element, wherein the actuator can be actuated at a frequency of larger than 10 Hz, preferably of larger than 30 Hz and particularly preferably of larger than 60 Hz, such as, e.g. with up to 90 Hz or with up to 250 Hz or with up to 450 Hz or with up to 1 kHz.

According to a further preferred embodiment of the invention at hand, the optical system has at least one laser scan module (scanner) for deflecting the laser beams onto the at least one solid body. The laser beams can preferably be introduced into the laser scan module via an inlet area and can be discharged from the laser scan module via an outlet area. The laser scan module preferably has a digitally controllable control device and one or more changing devices for changing the beam path of the laser beams, wherein the changing device(s) preferably comprise at least one galvanometer or the like.

According to a further preferred embodiment of the invention at hand, the laser scan module can be controlled in such a way that a different number of modifications, which are offset relative to one another in the radial direction, can be generated in response to a constant speed of the receiving portion in at least two sections of the solid body, which are radially spaced apart from the axis of rotation at different distances, in response to one rotation each. This embodiment is advantageous, because the scanner can thus generate modifications in response to each rotation on a plurality of modification paths, whereby the solid body needs to be moved or rotated through below the impinging location less frequently, whereby the laser treatment can be carried out completely more quickly.

According to a further preferred embodiment of the invention at hand, the optical system has at least one beam splitting element for splitting the radiation generated and emitted by the laser device into a plurality of preferably identical portions, wherein at least two of the plurality of radiation portions can be fed to the solid body for the simultaneous generation of modifications, wherein the radiation splitting element is preferably a diffractive element or a multispot lens. This embodiment is advantageous, because more than one modification, in particular two or more than two modifications, or three or more than three modifications, or four or more than four modifications, or five or more than five modifications, can be generated simultaneously. The radiation emitted by means of the laser device is in particular split into beams paths, which differ from one another at least in sections, wherein the radiation guided on two different beam paths at least in sections simultaneously generates a modification or a plurality of modifications, which are spaced apart from one another, in the solid body.

According to a further preferred embodiment of the invention at hand, provision is made for a repositioning device for repositioning the receiving portion or the receiving portion and the holding portion in an X-Y plane. Wherein the receiving portion for treating an outer solid body portion can be rotated and the receiving portion or the receiving portion and the holding portion can be repositioned in the X-Y plane in order to treat an inner solid body portion, which is surrounded by the outer solid body portion. This embodiment is advantageous, because the solid body is moved with the respectively most suitable movement principle for the treatment of individual areas, whereby—at least in certain cases—an accelerated treatment of the solid body can be effected with respect to the exclusive movement of the solid body by means of a movement principle (straight or in a rotatory manner).

According to a further preferred embodiment of the invention at hand, the receiving portion is embodied in such a way that a plurality of solid bodies are capable of being arranged at a distance to the axis of rotation on a surface of the receiving portion for the simultaneous or successive treatment. This embodiment is advantageous, because, in response to the movement of a solid body about an axis of rotation, the location speed also drops as the radius drops. Due to the fact that the individual solid bodies are spaced apart from the axis of rotation, the location speed does not drop to a range, which approaches 0 m/s.

According to a furhter preferred embodiment of the invention at hand, the receiving portion can be driven by the drive device in such a way that a modification path can be moved at a speed of more than 0.5 m/s and preferably of more than 3 m/s, preferably of more than 10 m/s and particularly preferably of more than 20 m/s or 30 m/s with respect to the laser device. This embodiment is advantageous, because the flow rate is increased with increasing speed. According to the invention at hand, 6-inch wafers, e.g., can be provided with modifications of a length of 10 μm and of a width of 2 μm in their interior, preferably holohedrally or substantially holohdrally, respectively, in less than 4 minutes, in particular in 3 minutes.

The invention at hand further relates to a method for treating solid bodies. The method according to the invention thereby preferably comprises at least the steps of continuously driving a receiving portion of a receiving device for receiving the solid body, wherein the receiving portion is held by means of a holding portion of the receiving device and is rotated about an axis of rotation, and the impinging of the solid body by laser beams to generate modifications in the solid body or on a surface of the solid body, wherein the laser beams are guided by means of an optical system, wherein the laser beams are deflected by means of the optical system in such a way that the solid body is impinged by the laser beams at different positions, wherein the solid body is impinged by the laser beams at different distances to the axis of rotation. According to a further preferred embodiment of the invention at hand, the modifications are generated by means of a laser radiation of at least one picosecond or femtosecond laser, which is introduced into the interior of the multi-layer assembly by means of an outer surface of the multi-layer assembly.

According to a further preferred embodiment of the invention at hand, the individual modifications or defects, respectively, or damaged spots, respectively, in each case result from a multi-photonic excitation, which is effected by the laser, in particular a femtosecond laser or a picosecond laser. The laser preferably has a pulse duration of below 10 ps, particularly preferably of below 1 ps and maximally preferably of below 500 fs.

According to a further preferred embodiment of the invention at hand, provision is made for a beam forming device for changing the properties of the impinging laser beams. These properties of the laser beams are in particular the polarization properties of the laser beams, the spatial profile of the laser beams prior to and after the focusing and the spatial and temporal phase distribution of the individual wavelengths of the impinging laser beams, which can be influenced by the wavelength-dependent dispersion into individual elements of the beam path, such as the focusing optical system.

For this purpose, the beam forming device can for example be equipped with a rotating half-wave plate or similar birefringent elements to change the polarization of continuous laser beams. The polarization of the impinging laser beams can thus be changed as a function of the rotational speed of the receiving portion. In addition, the polarization device can also be changed at a certain angle to crystal directions of the solid body on the receiving portion. For example, this can also be effected be an element similar to a Pockels cell in the beam forming device, in addition or as an alternative to the half-wave plate. In the case of such elements, an external electrical field effects a field-dependent double refraction in the material, the so-called Pockels effect or linear electrooptical effect, which can be used to change the polarization of laser beams as a function of the applied electrical voltage. This solution provides the advantage that it can have quicker switching times as compared to a rotating plate and can thus be synchronized better with the movement of the table or of the solid body, respectively.

In the alternative, the beam forming device can also be designed in such a way that the laser beams are polarized in a circular manner prior to the impinging of the solid body. Laser radiation is mostly linearly polarized, but can also be converted into circularly polarized light by means of birefringent optical elements, such as quarter-wave plates. Circularly polarized light, in contrast, is converted back into linearly polarized light again by using exactly such an element. It is also possible hereby for a mixed form or combination respectively, of circularly and linearly polarized laser radiation, so-called elliptically polarized laser radiation, to be used.

On principle, this provides a solution for the problem that in the case of the multi-photon absorption, the effective cross section is strongly dependent on the crystal direction or the angle between the polarization direction of the light, respectively, and the crystal orientation, because the crystal direction would change continuously with respect to the laser beam in response to the rotation of the solid body, this can be rectified by means of a synchronized rotation of the laser polarization or circularly or elliptically polarized laser light, and the effective cross section for the multi-photon absorption can be kept constant.

In addition, the beam forming device can be embodied in such a way that it changes the spatial profile of the laser beams prior to the focusing or in the focus. This can be attained in only one spatial direction by means of simple elements, such as a slit or telescope. Such a telescope can for example be attained from a combination of a cylinder lens with a cylinder diffusion lens, the relative focal length of which then prescribes the laser beam size distribution in a spatial direction. The telescope, however, can also consist of a plurality of elements in order to prevent a crossing of the laser beams. Depending on the spatial beam profile of the laser beams prior to the focusing, the shape of the focus can likewise be changed and chosen advantageously in response to the impinging of the solid body. For this purpose, the beam forming device can additionally be embodied such that the shape of the laser beam focus can also be changed as a function of the rotational speed of the receiving portion or also of the orientation of the solid body. In response to the impinging of the solid body in an area of the solid body, which is located closer to the axis of rotation, for example, a spatial profile, which is adapted thereto, can be generated in the focus by means of the beam forming device, such as, for example, a laser beam profile, which tapers to the outside.

Numerous materials, in particular transparent materials, such as glasses and crystals, are characterized by a wavelength-dependent refractive index. Laser beams in pulse form, in particular those in the femtosecond range, consist of a spectrum of wavelengths, which can experience different refractive indexes in a beam forming unit or in an optical system for focusing prior to the impinging of the solid body. This dispersion has the result that femtosecond laser pulses become longer, whereby the peak intensity thereof decreases, which is undesirable for the application of multi-photon processes. The beam forming unit can accordingly be embodied in such a way that it compensates dispersion of other optical elements in the beam path prior to or after the focusing. In the room, this dispersion can act as chromatic aberration or, in the time, it can act as pulse extension or pulse compression. The dispersion can in particular also be changed and used in such a way by means of the beam forming unit that a predefined color distribution of the wavelengths, which are present in the laser pulse, is created.

Common means for compensation and the introduction of artificial phase distributions in laser pulses, for example in order to compensate dispersion, are combinations of prisms or diffraction gratings, so-called spatial-light-modulators (SLMs), which are based on liquid crystals, or chirped mirrors, which have a specific sequence of dielectric layers of different diffractive indexes.

These solutions, in particular to compensate dispersion, is advantageous, because it compensates the problem that dispersions occur to an increased extent when passing through short pulses (e.g. smaller than 100 fs), i.e. the pulse dissolves, because some light portions are quicker than others. The pulse would otherwise become longer, whereby its peak intensity would decrease, which is undesirable when applying multi-photon processes.

According to a further preferred embodiment of the invention at hand, the energy of the laser beam, in particular of the fs laser, is chosen in such a way that the damage propagation in the transfer layer or in the crystal, respectively, is smaller than three-times the Reyleigh length, preferably smaller than the Reyleigh length, and particularly preferably smaller than one third of the Reyleigh length. According to a further preferred embodiment of the invention at hand, the wavelength of the laser beam, in particular of the fs laser, is chosen in such a way that the absorption of the transfer layer or of the material, respectively, is smaller than 10 cm−1 and preferably smaller than 1 cm−1 and particularly preferably smaller than 0.1 cm−1.

The solid body preferably has a material or a material combination of one of the main groups 3, 4 and 5 of the table of elements, such as, e.g., Si, SiC, SiGe, Ge, GaAs, InP, GaN, Al2O3 (sapphire), AlN. Particularly preferably, the solid body has a combination of elements from the third and fifth group of the periodic table. Possible materials or material combinations are thereby, e.g., gallium arsenide, silicon, silicon carbide, etc.. The solid body can furthermore have a ceramic (e.g. Al2O3—aluminum oxide (amorphous)) or can consist of a ceramic, preferred ceramics are thereby, e.g., perovskite ceramics (such as, e.g. Pb—, O—, Ti/Zr-containing ceramics) in general and lead-magnesium-niobates, barium titanate, lithium titanate, yttrium-aluminum-garnet, in particular yttrium-aluminum-garnet crystals for solid body laser applications, SAW ceramics (surface acoustic wave), such as, e.g. lithium niobate, gallium orthophosphate, quartz, calcium titanate, etc., in particular. The solid body thus preferably has a semiconductor material or a ceramic material or the carrier substrate and/or the wear layer particularly preferably consists or consist, respectively, of at least one semiconductor material, or of a ceramic material. It is furthermore conceivable that the solid body has a transparent material, in particular for laser radiation, or partially consists or is made, respectively, of a transparent material, in particular for laser radiation, such as, e.g. sapphire. Further materials, which are conceivable hereby as solid body alone or in combination with another material are, e.g., “wide band gap” materials, InAlSb, high-temperature superconductors, in particular rare earth cuprate (e.g. YBa2Cu307). In addition, or in the alternative, it is conceivable that the solid body is a photomask, wherein preferably each photomask material known on the filing date and particularly preferably combinations thereof can be used as photomask material in the case at hand.

According to a further preferred embodiment of the invention at hand, more than 5%, in particular more than 10% or more than 20% or more than 30% or more than 40% or more than 50% or more than 60% or more than 70% or more than 80% or more than 90% or more than 95% of the crystal lattice embodied during the course of the release area is changed, in particular damaged. This embodiment is advantageous, because the crystal lattice can be changed, e.g. by means of the laser loading, or because defects, in particular micro cracks, can be produced, respectively, in such a way that the forces required for removing the solid layer portion from the solid body can be adjusted. In terms of the invention at hand it is thus also possible that the crystal structure in the release area is modified or damaged in such a way, respectively, by means of laser radiation that the carrier substrate is released from the remaining multi-layer assembly as a result of the laser treatment or is removed therefrom through this, respectively.

In all cases, in which this word is used in connection with the invention at hand, the use of the word “substantially” preferably defines a deviation in the range of 1%-30%, in particular of 1%-20%, in particular of 1%-10%, in particular of 1%-5%, in particular of 1%-2%, from the determination, which would be at hand without the use of this word.

Further advantages, goals and characteristics of the invention at hand will be discussed by means of drawings enclosed to the description below, in which the apparatus according to the invention is illustrated in an exemplary manner. Components or elements of the apparatus according to the invention, which correspond at least substantially with regard to their function in the figures, can hereby be identified with the same reference numerals, whereby these components or elements do not need to be numbered or explained in all figures.

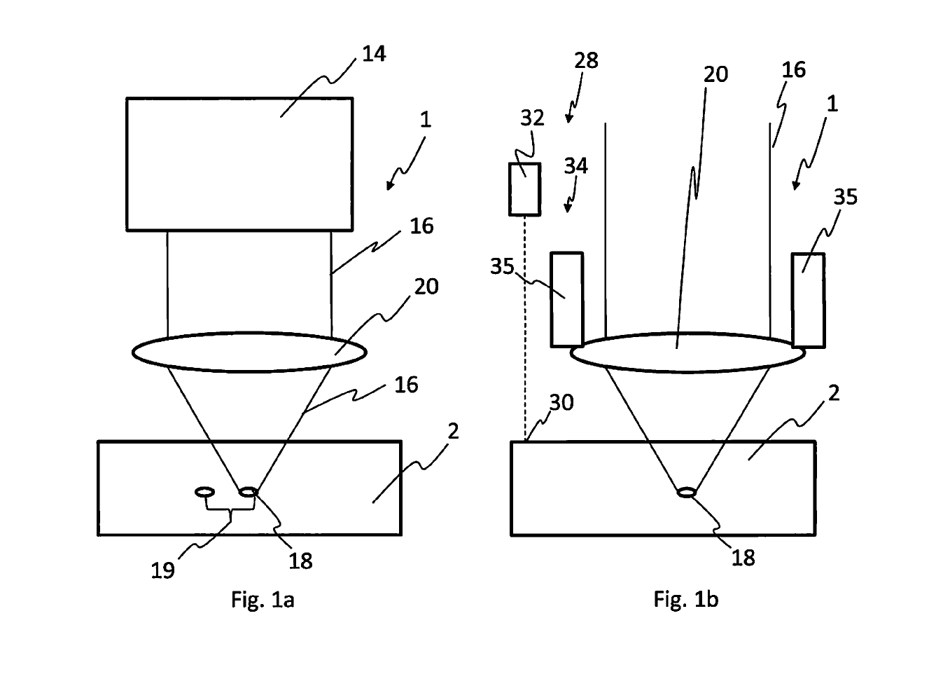

FIG. 1a shows a first partially and schematically illustrated setup of the apparatus according to the invention;

FIG. 1b shows a second partially and schematically illustrated setup of the apparatus according to the invention;

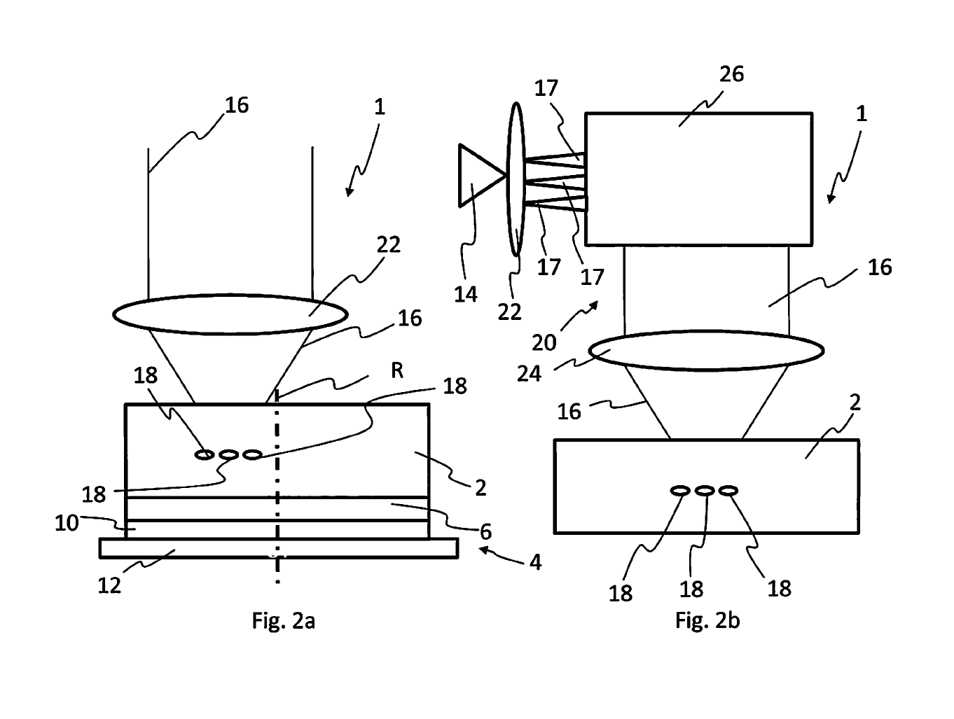

FIG. 2a shows a third partially and schematically illustrated setup of the apparatus according to the invention;

FIG. 2a shows a fourth partially and schematically illustrated setup of the apparatus according to the invention;

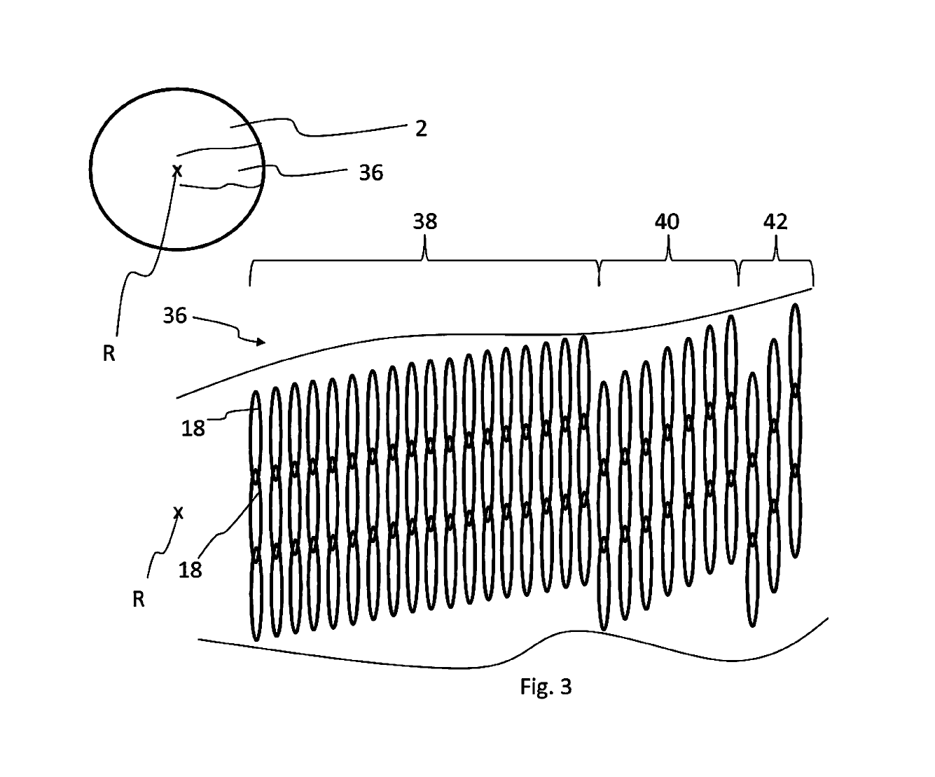

FIG. 3 shows a first schematic illustration of a defect production course;

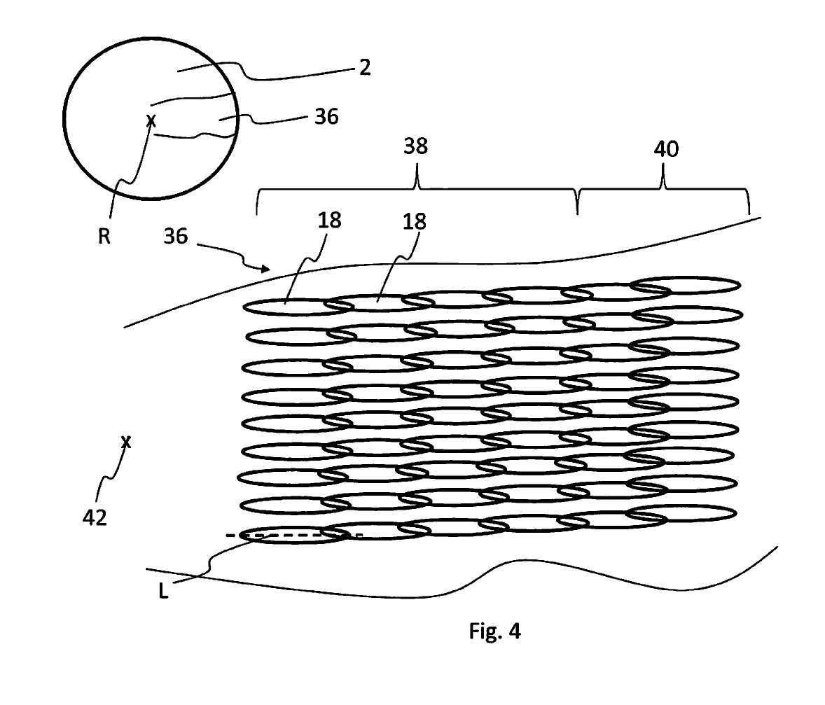

FIG. 4 shows a second schematic illustration of a defect production course;

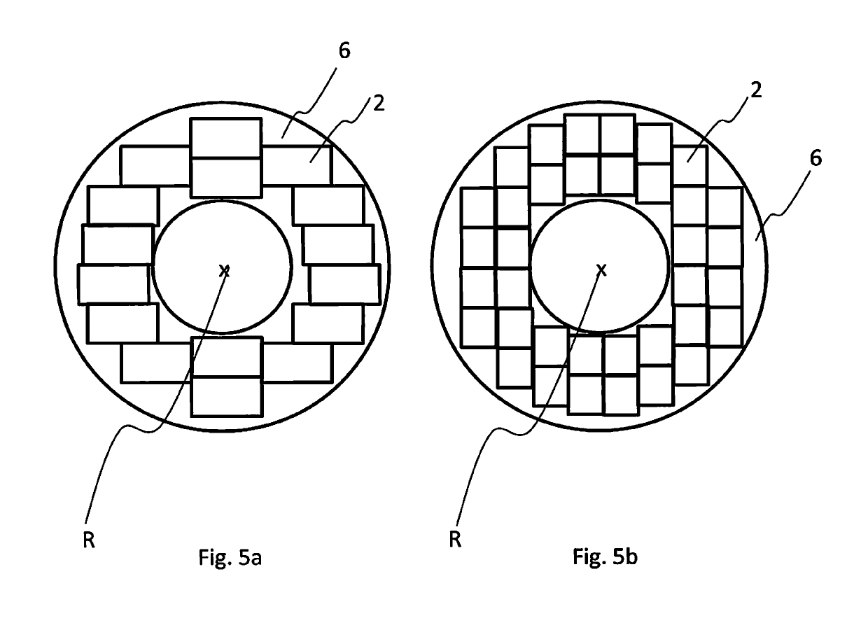

FIG. 5a shows a receiving portion, which is equipped with a first group of solid bodies, of the receiving device;

FIG. 5b shows a receiving portion, which is equipped with a second group of solid bodies, of the receiving device;

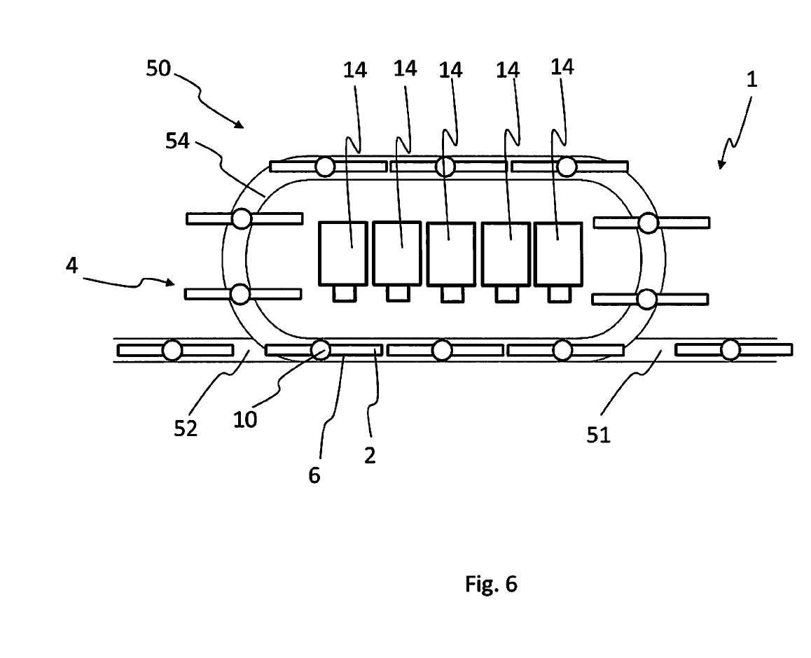

FIG. 6 shows a further schematic setup of an apparatus according to the invention and

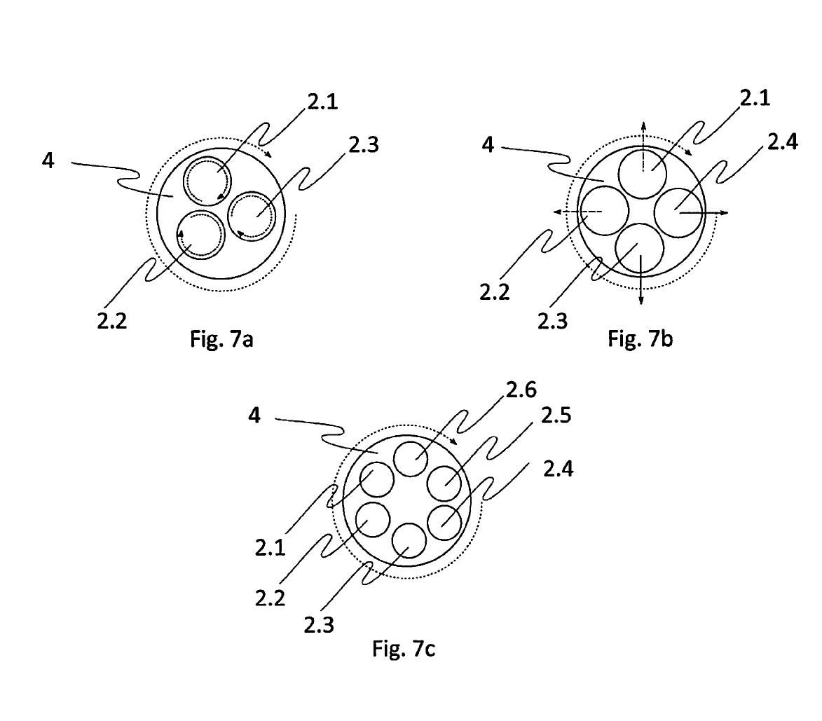

FIGS. 7a-7c show different arrangements, each comprising a plurality of solid bodies to be treated, which are coupled to a receiving device.

FIG. 1a shows, schematically, a laser device 14, a solid body 2, which is impinged by laser beams 16 of the laser device 14, and an optical system 20, which is arranged between the laser device 14 and the solid body 2, in an arrangement, which is possible according to the apparatus 1 according to the invention. The optical system 20 is thereby preferably arranged and embodied in such a way that modifications 18, in particular crystal lattice changes, such as cracks or local phase changes, can be generated on the surface of the solid body 2 or in the interior of the solid body 2, i.e. at a distance from a surface of the solid body 2. Particularly preferably, the modifications are generated in a focus point of the laser radiation. The laser device 14 thereby emits laser radiation 16 with a preferred pulse duration in the range of between preferably 100 fs and 1 ps and particularly preferably in the range of between 5 fs and 10 ps. A laser beam impingement in the above-mentioned range is advantageous, because only a small thermal impact or no thermal impact of the solid body 2 occurs, in particular in response to pulse durations of shorter than 10 fs. The pulse energy is thereby preferably larger than 1 nJ, in particular larger than 100 nJ or larger than 20 μl or larger than 200 μl or larger than 1 mJ or is up to 10 mJ or larger than 50 mJ or is up to 5 J. The repetition frequency is thereby preferably in a range of maximally, equal to or at least 1 kHz or of maximally, equal to or at least 1 MHz or of maximally, equal to or at least 20 MHz or of maximally, equal to or at least 50 MHz or of maximally, equal to or at least 80 MHz or of maximally, equal to or at least 100 MHz or of maximally, equal to or at least 250 MHz or of maximally, equal to or at least 1 GHz.

The average output of the laser device is thereby preferably larger than 1 W, in particular larger than 10 W or larger than 20 W or larger than 100 W or larger than 200 W or is up to 200 W or larger than 500 W or is up to 5 kW.

In response to repetition rages in the kHz to low MHz range, high pulse energies can generally be attained by means of amplifier systems, which boost laser radiation of an oscillator with certain initial repetition rate, pulse energy and pulse duration. However, a laser amplifier is not absolutely necessary for the application of multi-photon processes, but it is also possible to only work with the laser oscillator. Typically, this provides the advantage of higher pulse repetition rates. Laser oscillators, for example with titanium-sapphire crystals, can have repetition frequencies of 80 MHz or more at pulse durations of 7 fs or below, which may be suitable for some applications. Fiber lasers can have pulse repetition rates of between 250 kHz and 100 MHz and can moreover have flexibly adjustable pulse repetition rates. For specific applications, oscillators (fiber lasers and titanium-sapphire lasers) with repetition rates of up to 10 GHz or above exist. On principle, especially short laser pulses can be generated by means of the technique of the mode-locking, which can occur actively as well as passively.

The distance between two modifications 18, which are generated one after the other on a CURVED PATH, is preferably in the range of between 0.1 μm and 20 μm, the distance is in particular at least, maximally, substantially or exactly between 1 μm or 2 μm or 3 μm or 4 μm or 5 μm or 6 μm or 7 μm or 10 μm or 15 μm or 20 μm.

FIG. 1b shows an illustration, which is similar to FIG. 1a. The illustration according to FIG. 1b, however, also has a distance adaptation device 28. The distance adaptation device 28 thereby serves for the orientation of the optical system 20 or an element of the optical system with respect to the solid body 2 or for orienting the solid body 2 with respect to the optical system 20, respectively, or the element of the optical system, respectively. The distance adaptation device 28 preferably has a distance determination device 32 and preferably a deflection device 32 and preferably a deflection device 34. The distance determination device 32 preferably detects a distance between the distance determination device 32 and the solid body 2, in particular a surface portion 30, wherein the distance determination preferably occurs by means of a laser measurement. The surface portion 30, at which the measurement is made, is particularly preferably located on a path, on which, as a result of a movement of the solid body 2, the surface portion 30 is moved into the area of the laser impingement in such a way that a modification 18 is particularly preferably generated in the area of the surface portion 30 on the surface of the solid body 2 or in the interior of the solid body 2, in particular in beaming direction of the laser beams. The deflection device 34 comprises at least one actuator 35 for deflecting the optical system 20 or the solid body 2. The actuator 35 is thereby preferably a piezo element. This is advantageous, because distance corrections of less than 100 μm, preferably of less than 50 μm and particularly preferably of 1-2 μm can be effected by means of one or a plurality of piezo elements. Piezo elements are able to compensate 1 μm/ms, resulting in a 50 μm tolerance in the case of a round 300 mm receiving portion 6 (see FIG. 2a). The deflection device 34 thus preferably deflects an element of the optical system 20 or a plurality of elements of the optical system 20, in particular one or a plurality of optical lenses, orthogonally to the surface of the solid body 2, whereby the distance of the at least one optical element with respect to the solid body 2 is changed.

In FIG. 2a, the solid body 2 is arranged on a receiving device 4. The receiving device 4 preferably has a receiving portion 6 for receiving one or a plurality of solid bodies 2 and a holding portion 10 for holding the receiving portion 6. The receiving portion 6 can thereby preferably be rotated around the particularly preferably central axis of rotation R. A drive device (not shown) is thereby preferably a part of the receiving portion 6 and/or of the holding portion 10. The receiving portion 6 can preferably be rotated around the axis of rotation R at more than 1000 rotations per minute. Particularly preferably, the receiving device 4 is a rotary table, such as, e.g. a modified rotary table “Ultra Precision Rotation Stage UPR-270 AIR” from the company “PI”. The receiving portion 6 or the entire receiving device 4 can additionally be capable of being displaced by means of a further device 12. The further device 12 is hereby particularly preferably embodied in such a way that the solid body 2 can be displaced on a straight displacement path, in particular in an X-Y plane.

FIG. 2a further shows that a plurality of modifications 18 can be generated at the same time. The modifications 18 can thereby be generated spaced apart from one another or can overlap in sections and can thus represent a comparatively larger modification. It is conceivable hereby for the lens 22 to preferably be embodied as multispot lens, in particular as rod lens.

FIG. 2b shows a further embodiment of the apparatus 1 according to the invention for the simultaneous generation of a plurality of modifications 18. The arrangement hereby has an optical system 20, which preferably comprises at least a first lens 22, in particular a diffractive element, a second lens 24, in particular for focusing the laser beams 16, and a scanner 26. The laser device 14 thereby emits laser beams, which are divided into a plurality of beam paths 17, which are spaced apart from one another, by means of the diffractive element 22. When using a laser scan module 26, the division of the emitted laser beams 16 can occur before the radiation enters into the scanner 26 or after the radiation 16 exits from the scanner 26. The scanner “P-725.xDD PIFOC®”, e.g., by the company “PI” can hereby be used as scanner.

FIG. 3 shows an exemplary modification generation in a schematic manner by using a scanner 26. The scanner 26 deflects the laser beams 16 to a different number of modification paths, depending on the distance of the modification 18, which is to be generated, to the center of rotation (R) and/or depending on the respective location speed at the location, at which the modification 18 is to be generated. It can thus be seen that, in response to a rotation around the axis of rotation R, the location speed in the area 42 is larger than in the areas 40 and 38. As the radius decreases or as the location speed decreases, respectively, the scanner 26 thus effects the generation of modifications 18 on a larger number of modification paths. In the area 42, for example, only 3 modification paths are thus generated, whereas e.g. 7 modification paths are generated in the area 40, and e.g. 18 modification paths are generated in the area 38. The scanner 26 preferably guides the radiation 16 onto the solid body 2 in such a way that a modification 18 is initially generated on the inner or outer modification path of the respective area (38, 40, 42) and a modification 18 is subsequently generated in each case on the remaining modification paths of the same area. If modifications 18 have been generated on all modification paths of the area, the scanner 26 impinges the modification path again, which had been impinged first in this area, in order to then also impinge the other modification paths of the area again. In response to a rotational speed of e.g. 120 rotations per minute, modifications 18 can be generated on 10 modification paths in the outer area 42, and modifications 18 can be generated on 50 modification paths, e.g., in an inner area 38. The specified number of areas 38, 40, 42, is to be understood only as an example. It is also possible for provision to be made for more than 3 areas, in particular up to, exactly or more than 5, or up to, exactly or more than 10, or up to, exactly or more than 20, or up to, exactly or more than 50, or up to, exactly or more than 100 areas, which are defined with different numbers of modification paths. The number of the modification paths per area increases, e.g. depending on a specified function, in particular with 1/R. The modifications 18 preferably have a form, in the case of which the length of the modification is larger than the width of the modification by the factor 2 or 3 or 4 or 5 or 6 or 7 or 8 or 9 or 10. The modifications 18 preferably have a length of 10 μm and a width of 2 μm or are substantially 10 μm long and 2 μm wide or are exactly 10 μm long and 2 μm wide. It is further conceivable hereby that the modifications 18 of adjacent modification paths overlap one another in sections or adjoin one another exactly or are generated at a distance from one another. The modifications 18 of adjacent modification paths are preferably generated at a distance of less than 50 μm and preferably at a distance of less than 20 μm and particularly preferably at a distance of less than 5 μm relative to one another.

The frequency of the laser device in the vicinity (1-2 mm) of the axis of rotation or of the center of the solid body, respectively, can thus be lowered to a very large extent (factor 100-1000) and the additional stress in the exact center can thus be minimized. The use of a scanner is advantageous hereby, because the accuracy, with which the lens is oriented to the exact center of the rotary table, does not need to be so exact (in particular, when the exact center is approached up to half the strip width). Accuracies of 10 μm can be reached very well. A lens holder or a holder for holding the scanner (not shown), respectively, or the scanner 26 can preferably also be adjusted in the X-Y direction or linearly, respectively.

As compared to FIG. 3, FIG. 4 illustrates modifications 18, which are generated so as to be rotated by 90°, the longitudinal axes L of the modifications 18 in particular extend substantially or completely in the radial direction in accordance with this illustration.

FIG. 5a and FIG. 5b in each case show an embodiment of the invention at hand, according to which the solid bodies 2, which are arranged closest to the axis of rotation in the radial direction, can be moved with a significantly higher location speed in response to a rotation around the axis of rotation R as a result of an arrangement, which is spaced apart thereto. In FIG. 5a, the solid bodies 2 can hereby be, e.g., wafers or transparent bodies, such as donor substrates for display protection layers. FIG. 5b clarifies that the maximum receiving capacity of the receiving portion 6 is significantly larger as the solid body size decreases, because less unused receiving surface of the receiving portion 6 remains. The solid bodies 2 shown in FIG. 5b can be, e.g. display protection layers of watches, in particular of smart watches, or protection layers for camera lenses or fingerprint sensors.

FIG. 6 shows a further embodiment according to the invention of the invention at hand. Reference numeral 50 hereby identifies a guide path, by means of which the solid body 2, which is arranged on receiving devices 4, can be moved continuously underneath one or a plurality of laser devices 14, in particular without change in direction. In the case of a plurality of laser devices 14, it is conceivable that the laser devices 14 are arranged at different depths in the image plane and that a plurality of straight modifications paths can thus be generated for each conveying round or in a solid body 2. The holding portion 10 thereby preferably couples the receiving portion 6 to the guide path 50. Reference numeral 51 preferably identifies a feed area or feed section, respectively, for feeding the receiving devices 4 to the treatment apparatus 1. A return area 54 preferably serves to convey the receiving devices 4 back to the laser impingement. The receiving devices 4 with the solid bodies 2, which are completely treated, can preferably be guided out of the treatment apparatus 1 via a discharge section 52.

As in the case of the other exemplary embodiments, it is also conceivable for provision to be made for a distance adaptation device 28 (not shown) and for an optical system 20 (not shown).

The invention at hand thus refers to an apparatus 1 for treating solid bodies 2. The apparatus according to the invention comprises at least one receiving device 4 comprising a receiving portion 6 for receiving the solid body 2 and comprising a holding portion 10 for holding the receiving portion 6, wherein the receiving portion 6 can be driven continuously by means of a drive device, a laser device 14 for providing laser beams 16 for generating modifications 18 in the solid body 8 or on a surface 20 of the solid body 2, and an optical device 20 for guiding the laser beams 16, wherein the laser beams 16 can be deflected by means of the optical system 20 in such a way that the solid body 2 can be impinged by the laser beams 16 at different positions.

FIGS. 7a-7c show different schematic arrangements, according to which a plurality of solid bodies 4 can be coupled, in particular simultaneously, to a receiving device 4. It is conceivable hereby that the plurality of solid bodies 2.1, 2.2, 2.3, 2.4, 2.5, 2.6 partially overlap one another or touch one another or are spaced apart from one another. All solid bodies preferably have a surface, which is spaced apart from the receiving device 4, in particular the surface, via which the laser beams penetrate into the solid body 2.1, 2.2, 2.3, 2.4, 2.5, 2.6. The solid bodies 2.1, 2.2, 2.3, 2.4, 2.5, 2.6 are preferably arranged in such a way that these surfaces are substantially or exactly located in the same plane. Substantially hereby preferably refers to a deviation of less than 2 mm, in particular of less than 1 mm or of less than 0.5 mm or of less than 0.1 mm or of less than 0.05 mm or of less than 0.01 mm. It can further be gathered from each of the illustrations 7a-7c that the receiving device 4 is preferably rotated, the receiving device 4 is in particular treated with constant or changeable, in particular increasing or decreasing angular speed during the treatment. The receiving device 4 is preferably rotated about its center. The individual solid bodies 2.1, 2.2, 2.3, 2.4, 2.5, 2.6 are preferably arranged concentrically, in particular adhered to the receiving device 4. In these embodiments, but also in all other embodiments mentioned herein, the form of the receiving device 4 can deviate from a round form, wherein the form of the receiving device 4 is preferably round. The number of the plurality of solid bodies, which can be moved by means of a receiving device 4, is preferably two or at least two or exactly two or preferably three or at least three or exactly 4 or preferably 4 or at least 4 or exactly 5 or preferably 5 or at least 5 or exactly 6 or preferably 6 or at least 6 or preferably 10 or at least 10 or exactly 10.

FIG. 7a shows, merely in an exemplary manner, that the individual solid bodies 4 can be arranged so as to movable with respect to the receiving device 4, in particular so as to be rotatable and/or displaceable. The individual solid bodies 2.1, 2.2, 2.3 are in each case preferably coupled to a movement device. The movement device is preferably embodied to set the respective solid body 2.1, 2.2, 2.3, which is coupled thereto, into a further movement in response to a rotation of the receiving device 4. The further movement is preferably a rotation. The movement of the individual movement devices is thereby preferably adapted to one another. The individual movement devices can preferably be moved at the same speed or at different speeds. The movement devices can preferably be operated simultaneously or shifted in time. The movement devices further preferably effect a rotation and/or a radial displacement (see FIG. 7b) of the respective solid body with respect to the receiving device 4. The direction of rotation of the individual movement devices can take place in the same direction, whereby it is also conceivable that one or a plurality of the movement devices is rotated in a direction opposite to the direction of rotation of the plurality of the movement devices. The treatment of the solid body preferably takes place as a function of the rotation of the receiving device 4 and particularly preferably also as a function of the movement speed of the individual movement devices. In addition or in the alternative, the treatment of the solid bodies takes place as a function of the orientation of the receiving device 4 and particularly preferably also as a function of the orientation of the individual movement devices with respect to the receiving device and/or with respect to the laser device. Preferably, the light beams, which can be emitted for the generation of the modifications, will preferably always irradiate the solid bodies along one or the same line, respectively, which can be specified by coordinates, wherein the line is preferably stationary with respect to the total system, in particular with respect to the surrounding area. In the alternative, it is conceivable that the light beams, which can be emitted for the generation of the modifications, preferably always irradiate the solid bodies in one or the same point, respectively, which can be specified by coordinates, wherein the point is preferably stationary with respect to the total system, in particular with respect to the surrounding area. FIG. 7a shows that the directions of rotation of the movement devices preferably corresponds to the direction of rotation of the receiving device. However, it is also conceivable hereby that the directions of rotation of individual or of all movement devices do not always or temporarily correspond or are in the opposite direction, respectively.

FIG. 7b shows that the direction of movement can be embodied for the radial repositioning, in particular shifting or displacing, of the solid bodies. A rotation of the receiving device 4 and additionally a temporary or continuous radial repositioning of one or a plurality of solid bodies thus preferably occurs by means of the respective movement device. The treatment of the solid bodies can thereby take place in response to a radial repositioning of the solid bodies in the direction of the center of the receiving device 4 and/or in response to a radial repositioning of the solid bodies in opposite direction. It is furthermore conceivable that the solid bodies are in each case repositioned gradually in the radial direction by means of the movement devices and that the treatment takes place between the repositioning steps. In addition, it is conceivable that a solid body, a plurality of solid bodies, the plurality of the solid bodies, a minority of the solid bodies or all solid bodies to also be rotated simultaneously or time-delayed to one another. The treatment of the solid bodies preferably takes place as a function of the rotation of the receiving device 4 and particularly preferably also as a function of the movement speed of the individual movement devices. In addition or in the alternative, the treatment of the solid bodies takes place as a function of the orientation of the receiving device 4 and particularly preferably also as a function of the orientation of the individual movement devices with respect to the receiving device and/or with respect to the laser device.

FIG. 7c shows purely as an example that a plurality of solid bodies 2.1, 2.2, 2.3, 2.4, 2.5, 2.6 can be received by the receiving device 4 and can be rotated by the latter. A treatment of the individual solid bodies 2.1, 2.2, 2.3, 2.4, 2.5, 2.6 preferably takes place by means of the optical system, in particular the laser scanner. This is preferably effected analogously to the embodiments described in FIG. 5a or 5b.

The invention at hand refers to an apparatus 1 for treating solid bodies 2. The apparatus according to the invention comprises at least one receiving device 4 comprising a receiving portion 6 for receiving the solid body 2 and comprising a holding portion 10 for holding the receiving portion 6, wherein the receiving portion 6 can be driven continuously by means of a drive device, a laser device 14 for providing laser beams 16 to generate modifications 18 in the solid body 8 or on a surface 20 of the solid body 2, and an optical system 20 for guiding the laser beams 16, wherein the laser beams 16 can be deflected by means of the optical system 20 such that one or a plurality of solid bodies 2 can be impinged by the laser beams 16 at different positions.

### LIST OF REFERENCE NUMERALS

1 apparatus

2 solid body

4 receiving device

6 receiving portion

10 holding portion

12 repositioning device

14 laser device

16 laser beams

17 divided laser beams

18 modification

19 distance between two modifications

20 optical system

22 lens

24 further lens

26 scanner

28 distance adaptation device

30 surface portion

32 distance determination device

34 deflection device

35 actuator

36 partial area

38 first radius area

40 second radius area

42 third radius area

50 guide path

51 feed section

52 discharge section

54 return section

1.-15. (canceled)

16. An apparatus for forming a release area or a plurality of partial release areas in the interior of solid bodies, at least comprising:
a receiving device comprising a receiving portion for receiving at least one solid body and comprising a holding portion for holding the receiving portion, wherein the receiving portion can be continuously driven by means of a drive device,
a laser device for providing laser beams to generate modifications by means of multi-photonic excitation in the interior of the at least one solid body,
an optical system for guiding the laser beams, wherein the laser beams can be deflected by means of the optical system such that the at least one solid body can be impinged by the laser beams at different positions, wherein the receiving portion is supported so as to be capable of rotating about an axis of rotation, wherein the one or a plurality of solid bodies can be impinged by the laser beams at varying distances to the axis of rotation.

17. The apparatus according to claim 16 characterized in that the rotational speed of the receiving portion can be varied by means of the drive device as a function of the distance of the location, at which the laser beams penetrate the solid body, to the axis of rotation, wherein the rotational speed preferably increases to the axis of rotation in response to a decrease of the distance of the location, at which the laser beams penetrate the solid body.

18. The apparatus according to claim 16 characterized in that the receiving portion can be rotated about the axis of rotation at more than 100 revolutions per minute, preferably at more than 1000 revolutions per minute and particularly preferably at more than 1500 revolutions per minute and laser beams can be emitted by the laser device at a frequency of at least 0.5 MHz, preferably of at least 1 MHz and particularly preferably of at least 5 MHz or 10 MHz for generating the modifications.

19. The apparatus according to claim 16 characterized in that provision is made for a distance adaptation device for adapting the distance of at least one element of the optical system with respect to a surface portion of the surface of the solid body, wherein the distance adaptation device comprises at least one distance determination device to determine a distance of a surface portion of the solid body with respect to the distance determination device and a deflection device to adapt the distance of the at least one element of the optical system with respect to the surface portion of the solid body as a function of the distance between the surface portion of the solid body and the distance determination device determined by the distance determination device.

20. The apparatus according to claim 19 characterized in that the distance determination device is arranged in such a way that the distance determination occurs at a location, which differs from the location of the introduction of the laser beams into the solid body, wherein the location of the distance determination and the location, at which the laser radiation penetrates the solid body, are located on the same circular path around the axis of rotation, wherein the location of the distance determination and the location, at which the laser beams penetrate the solid body, are spaced apart from one another by less than 270°, preferably by less than 180°, and particularly preferably by less than 90°.

21. The apparatus according to claim 20 characterized in that at least the one element of the optical system can be deflected in such a way by means of the deflection device that distance changes between the optical system and the surface portion of the solid body can be compensated least partially, wherein the deflection device can be controlled as a function of the rotational speed of the receiving portion in such a way that the laser beams for generating the modification(s) penetrate the solid body through the surface of the surface portion of the solid body, at which the distance measurement occurred beforehand.

22. The apparatus according to claim 21 characterized in that the deflection device has at least one actuator, in particular a piezo element, wherein the actuator can be actuated at a frequency of larger than 10 Hz, preferably of larger than 30 Hz and particularly preferably of larger than 60 Hz.

23. The apparatus according to claim 16 characterized in that the optical system has at least one laser scan module for deflecting the laser beams onto the solid body, wherein the laser scan module can be controlled in such a way that a different number of modifications, which are offset relative to one another in the radial direction, can be generated in response to a constant speed of the receiving portion in at least two sections of the solid body, which are radially spaced apart from the axis of rotation at different distances, in response to one rotation each

24. The apparatus according to claim 16 characterized in that the optical system has at least one beam splitting element for splitting the radiation generated and emitted by the laser device into a plurality of preferably identical portions, wherein at least two of the plurality of radiation portions can be fed to the solid body for the simultaneous generation of modifications, wherein the radiation splitting element is preferably a diffractive element or a multispot lens.

25. The apparatus according to claim 16 characterized in that provision is made for a repositioning device for repositioning the receiving portion or the receiving portion and the holding portion in an X-Y plane and wherein the receiving portion in order to treat an outer solid body portion can be rotated and the receiving portion or the receiving portion and the holding portion can be repositioned in the X-Y plane in order to treat a solid body portion, which is surrounded by the outer solid body portion.

26. The apparatus according to claim 16 characterized in that the receiving portion is embodied in such a way that a plurality of solid bodies are capable of being arranged at a distance to the axis of rotation on a surface of the receiving portion for the simultaneous or successive treatment.

27. The apparatus according to claim 16 characterized in that the receiving portion can be driven by the drive device in such a way that a modification path can be moved at a speed of more than 0.5 m/s and preferably of more than 3 m/s, preferably of more than 10 m/s and particularly preferably of more than 20 m/s or 30 m/s with respect to the laser device.

28. The apparatus according to claim 16 characterized in that provision is made for a beam forming device for changing the properties of the impinging laser beams, in particular a device for changing the polarization of the laser beams, in particular in the form of a rotating half-wave plate or a Pockels cell, and/or the beam forming device is equipped to polarize the laser beams in a circular or elliptical manner, wherein the solid body can be impinged by the circularly or elliptically polarized laser beams, in particular in the form of quarter-wave plates.

29. The apparatus according to claim 28 characterized in that:
the beam forming device is embodied to effect the polarization direction of the laser beams as a function of a rotational speed of the receiving portion and/or as a function of an orientation of the solid body, in particular of the orientation of its crystal directions relative to the polarization of the impinging laser beams, wherein the beam forming device preferably comprising a rotating half-wave plate and/or Pockels cell, wherein the Pockels cell is impinged by an applied voltage as a function of the current rotational movement and/or
the beam forming device is designed in such a way that the focus of the laser beams can be changed as a function of the pulse speed and/or of the rotational speed of the receiving portion and/or of the orientation of the solid, wherein the beam forming device preferably comprises one or a plurality of deformable mirrors and/or a cylinder lens combination, and/or
the beam forming device is additionally embodied to design the spatial profile of the laser beams, in particular in such a way that the focus of the laser beams, in particular the spatial profile of the focus of the laser beams, can be changed by means of the beam forming device, wherein the beam forming device preferably comprises a telescope, and/or
the beam forming device is additionally embodied to change the spatial and/or temporal dispersion of the laser beams, in particular the temporal dispersion of the optical system, wherein the radiation device preferably comprises a prism combination and/or diffraction grating combination and/or chirped mirrors.

30. A method for forming a release area or a plurality of partial release areas in the interior of solid bodies, at least comprising:
continuously driving a receiving portion of a receiving device for receiving the solid body, wherein the receiving portion is held by means of a holding portion (10) of the receiving device and is rotated about an axis of rotation,
impinging the solid body by laser beams to generate modifications by means of multi-photonic excitation in the solid body,
wherein the laser beams are guided by means of an optical system, wherein the laser beams are deflected by means of the optical system in such a way that the solid body is impinged by the laser beams at different positions, wherein the solid body is impinged by the laser beams at different distances to the axis of rotation.
